(19) United States
(12) Patent Application Publication
(10) Pub. No.: US 2025/0229798 A1
(43) Pub. Date: Jul. 17, 2025

(54) NOTIFICATION DEVICE, NOTIFICATION METHOD, AND NOTIFICATION PROGRAM

(71) Applicant: TOYOTA JIDOSHA KABUSHIKI KAISHA, Aichi-ken (JP)

(72) Inventor: Dai TONUMA, Toyota-shi (JP)

(21) Appl. No.: 19/012,854

(22) Filed: Jan. 8, 2025

(30) Foreign Application Priority Data
Jan. 12, 2024 (JP) 2024-003469

(51) Int. Cl. B60W 50/14; B60W 40/08; G06V 20/59; G06V 40/18

(52) U.S. Cl. CPC B60W 50/14; B60W 40/08; G06V 20/597; G06V 40/18; B60W 2040/0818; B60W 2050/143; B60W 2050/146; B60W 2420/403; B60W 2540/225; B60W 2540/229; B60W 2554/802

(57) ABSTRACT

A notification device that notifies a driver of a host vehicle of a start of movement of a preceding vehicle that is in a stopped state in front of the host vehicle, includes: a determination unit which determines whether the driver is visually checking a forward direction; a state detection unit which detects a state of the preceding vehicle; and a notification unit notifies the driver of the start of movement. The notification unit changes a notification mode of notifying the driver of the start of movement, between a case where the driver is visually checking the forward direction and a case where the driver is not visually checking the forward direction. The notification mode includes at least one of a timing of a notification, presence or absence of the notification, and a notification method.

### TECHNICAL FIELD

The present disclosure relates to a notification device, a notification method, and a notification program.

### BACKGROUND

A vehicle-to-vehicle distance warning device of the related art (JP 2000-338240 A) is known that transmits ultrasonic waves toward a preceding vehicle when stopped in a traffic jam, captures reflected waves, detects that a vehicle-to-vehicle distance between a host vehicle and the preceding vehicle has reached a predetermined distance as a result of that the preceding vehicle has started to move, and notifies a driver.

### SUMMARY

In the device described in JP 2000-338240 A, the notification to the driver is uniformly performed when the vehicle-to-vehicle distance reaches the predetermined distance, regardless of the state of the driver. Therefore, if this predetermined distance is set to be long, there is a possibility that the notification to the driver is delayed in a case where the driver is looking aside or dozing and does not perceive the start of movement of the preceding vehicle. On the other hand, if this predetermined distance is set to be short, there is a possibility that the notification to the driver is performed even when the driver is paying attention to the forward direction and perceives the start of movement of the preceding vehicle, simply due to the operation of the driver being slightly delayed.

In view of the problem described above, an object of the present disclosure is to notify a driver of a start of movement of a preceding vehicle in accordance with the state of the driver.

The gist of the present disclosure is as follows.

(1) A notification device that notifies a driver of a host vehicle of a start of movement of a preceding vehicle that is in a stopped state in front of the host vehicle, the notification device comprising:
a determination unit which determines whether the driver is visually checking a forward direction;
a state detection unit which detects a state of the preceding vehicle; and
a notification unit notifies the driver of the start of movement of the preceding vehicle, wherein
the notification unit changes a notification mode of notifying the driver of the start of movement of the preceding vehicle, between a case where it is determined that the driver is visually checking the forward direction and a case where it is determined that the driver is not visually checking the forward direction, the notifying being based on the state of the preceding vehicle detected by the state detection unit, and
the notification mode includes at least one of a timing of a notification, presence or absence of the notification, and a notification method.

(2) The notification device according to above (1), wherein
the notification unit notifies the driver of the start of movement of the preceding vehicle at an earlier timing, from the start of movement of the preceding vehicle, when it is determined that the driver is not visually checking the forward direction, compared to when it is determined that the driver is visually checking the forward direction.

(3) The notification device according to above (2), wherein
when it is determined that the driver is visually checking the forward direction, the notification unit notifies the driver of the start of movement of the preceding vehicle when a movement amount of the started preceding vehicle becomes equal to or greater than a first movement amount, and, when it is determined that the driver is not visually checking the forward direction, the notification unit notifies the driver of the start of movement of the preceding vehicle when the movement amount of the started preceding vehicle becomes equal to or greater than a second movement amount, the second movement amount being smaller than the first movement amount.

(4) The notification device according to above (2), wherein
when it is determined that the driver is visually checking the forward direction, the notification unit notifies the driver of the start of movement of the preceding vehicle when an elapsed time from the preceding vehicle starting to move becomes equal to or greater than a first time period, and, when it is determined that the driver is not visually checking the forward direction, the notification unit notifies the driver of the start of movement of the preceding vehicle when the elapsed time from the preceding vehicle starting to move becomes equal to or greater than a second time period, the second time period being shorter than the first time period.

(5) The notification device according to above (2), wherein
when it is determined that the driver is visually checking the forward direction, the notification unit notifies the driver of the start of movement of the preceding vehicle when a distance from the host vehicle to the preceding vehicle becomes equal to or greater than a first distance, and, when it is determined that the driver is not visually checking the forward direction, the notification unit notifies the driver of the start of movement of the preceding vehicle when the distance from the host vehicle to the preceding vehicle becomes equal to or greater than a second distance, the second distance being less than the first distance.

(6) The notification device according to above (1), wherein
when the determination unit determines that the driver is visually checking the forward direction, the notification unit does not notify the driver of the start of movement of the preceding vehicle even when the state detection unit detects the start of movement of the preceding vehicle.

(7) A notification method performed by a processor of a host vehicle for notifying a driver of the host vehicle of a start of movement of a preceding vehicle that is in a stopped state in front of the host vehicle, the notification method comprising:
determining whether the driver is visually checking a forward direction;
detecting a state of the preceding vehicle; and
notifying the driver of the start of movement of the preceding vehicle, wherein
when notifying the driver of the start of movement of the preceding vehicle, a notification mode of notifying the driver of the start of movement of the preceding vehicle is changed, between a case where it is determined that the driver is visually checking the forward direction and a case where it is determined that the driver is not visually checking the forward direction, the notifying being based on the state of the preceding vehicle, and
the notification mode includes at least one of a timing of a notification, presence or absence of the notification, and a notification method.

(8) A notification program for notifying a driver of a host vehicle of a start of movement of a preceding vehicle that is in a stopped state in front of the host vehicle, the notification program causing a computer to execute:
determining whether the driver is visually checking a forward direction;
detecting a state of the preceding vehicle; and
notifying the driver of the start of movement of the preceding vehicle, wherein
when notifying the driver of the start of movement of the preceding vehicle, a notification mode of notifying the driver of the start of movement of the preceding vehicle is changed, between a case where it is determined that the driver is visually checking the forward direction and a case where it is determined that the driver is not visually checking the forward direction, the notifying being based on the state of the preceding vehicle, and
the notification mode includes at least one of a timing of a notification, presence or absence of the notification, and a notification method.

### BRIEF DESCRIPTION OF DRAWINGS

FIG. 1 is a schematic block diagram illustrating a configuration of a notification system.

FIG. 2 is a schematic side view partially illustrating an interior of a vehicle equipped with the notification system.

FIG. 3 is a functional block diagram of a processor of an ECU.

FIGS. 4A and 4B are diagrams for explaining the timing of notifying a start of movement of a preceding vehicle.

FIG. 5 is a flowchart illustrating a flow of notification processing performed by a notification device.

FIG. 6 is a flowchart illustrating a flow of notification processing performed by the notification device according to a second embodiment.

### DESCRIPTION OF EMBODIMENTS

Hereinafter, embodiments will be described in detail with reference to the drawings. In the following description, similar components are denoted by the same reference numerals.

### First Embodiment

### Configuration of Notification System

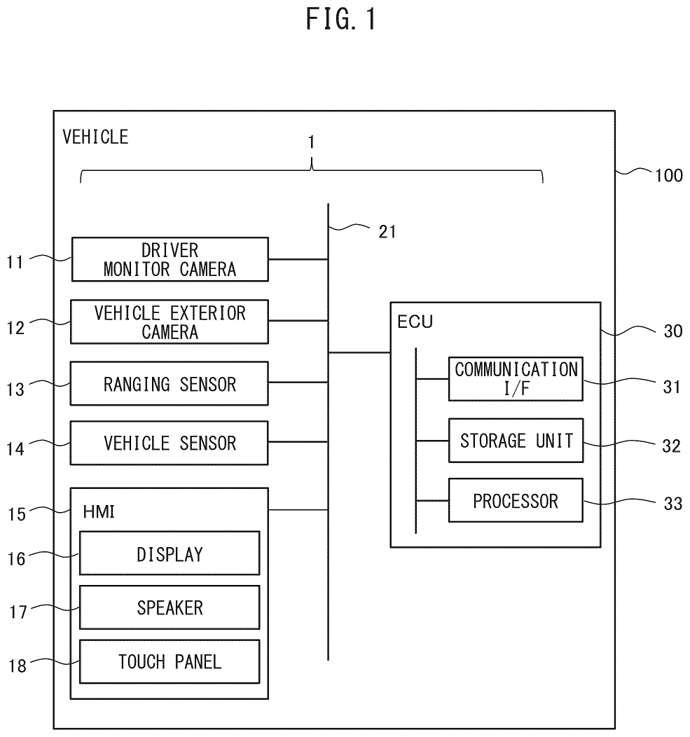

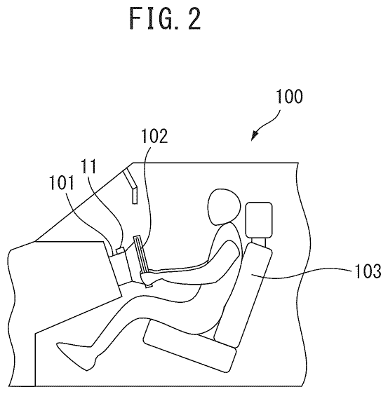

A configuration of a notification system 1 including a notification device according to one embodiment will be described with reference to FIGS. 1 to 3. The notification device notifies a driver of a vehicle (host vehicle) 100 of a start of movement of a preceding vehicle that has been in a stopped state in front of the host vehicle. FIG. 1 is a schematic block diagram illustrating a configuration of the notification system 1. FIG. 2 is a schematic side view partially illustrating the interior of the vehicle 100 equipped with the notification system 1.

The notification system 1 is mounted at the vehicle 100, and notifies the driver of the vehicle 100 of the start of movement of the preceding vehicle. As illustrated in FIG. 2, the vehicle 100 includes a steering wheel 102 attached via a steering column 101, and a driver seat 103 on which the driver sits.

As illustrated in FIG. 1, in the present embodiment, the notification system 1 includes a driver monitor camera 11, a vehicle exterior camera 12, a ranging sensor 13, a vehicle sensor 14, a human machine interface (HMI) 15, and an electronic control unit (hereinafter referred to as an “ECU”) 30. The driver monitor camera 11, the vehicle exterior camera 12, the ranging sensor 13, the vehicle sensor 14, the HMI 15, and the ECU 30 are communicably connected to each other via, for example, an in-vehicle network 21. The in-vehicle network 21 is a network conforming to a standard such as a controller area network (CAN), for example.

The driver monitor camera 11 captures an image of the face of the driver. In the present embodiment, the driver monitor camera 11 is provided at the upper portion of the steering column 101, and is disposed to face the driver so as to be able to capture an image of the driver, specifically, an image of the face and a part of the upper body of the driver. Note that, the driver monitor camera 11 may be provided at a position different from the upper portion of the steering column 101 as long as the driver monitor camera 11 can capture the image of the driver of the vehicle 100. For example, the driver monitor camera 11 may be provided at the steering wheel 102, a room mirror, a meter panel, and a meter hood of the vehicle 100.

The driver monitor camera 11 includes a camera and an illuminator. For example, the camera is a complementary metal oxide semiconductor (CMOS) camera or a charge coupled device (CCD) camera, and the illuminator is a light emitting diode (LED). Further, the illuminator is preferably a near-infrared LED, and the camera is preferably capable of detecting near-infrared rays so that the face of the driver can be imaged without giving discomfort to the driver even at a time of low illuminance such as at night. For example, the illuminator is constituted by two near-infrared LEDs disposed on either side of the camera. Further, the camera may be provided with a filter such as a visible light cut filter. The driver monitor camera 11 outputs a captured image to the ECU 30 via the in-vehicle network 21 at a predetermined interval.

The vehicle exterior camera 12 is a device that captures images of the surroundings of the vehicle. In the present embodiment, the vehicle exterior camera 12 captures an image of the forward direction of the vehicle 100. The vehicle exterior camera 12 is a CMOS camera or a CCD camera having sensitivity to visible light. In the present embodiment, the vehicle exterior camera 12 is attached, for example, at the interior of the vehicle 100 so as to face the forward direction of the vehicle 100. The vehicle exterior camera 12 captures an image of a forward direction region of the vehicle 100 at a predetermined capturing interval and generates an image of the captured forward direction region. Each time an image is generated, the vehicle exterior camera 12 outputs the generated image to the ECU 30 via the in-vehicle network 21. Note that the vehicle exterior camera 12 may be a monocular camera or a stereo camera. In a case where the stereo camera is used as the vehicle exterior camera 12, the vehicle exterior camera 12 also functions as the ranging sensor 13. The vehicle 100 may be provided with a plurality of vehicle exterior cameras having different capturing directions or focal distances.

The ranging sensor 13 is a sensor that measures the distance to an object present in the surroundings of the vehicle 100. In particular, in the present embodiment, the ranging sensor 13 measures the distance to the object present in the forward direction of the vehicle 100. Further, in the present embodiment, the ranging sensor 13 can also measure the azimuth of an object present in the surroundings of the vehicle 100. The ranging sensor 13 is, for example, a radar such as a millimeter wave radar or a LIDAR. Furthermore, the ranging sensor 13 may be configured to be able to measure a relative speed with respect to an object present in the surroundings of the vehicle 100. In the present embodiment, the ranging sensor 13 measures the distance to the object present in the forward direction of the vehicle. The ranging sensor 13 outputs a measurement result of a distance to the surrounding object to the ECU 30 via the in-vehicle network 21 at a predetermined interval.

The vehicle sensor 14 is a sensor that detects the state of the vehicle 100. In the present embodiment, the vehicle sensor 14 is a sensor that can be used to detect or estimate the speed of the vehicle 100. Specifically, the vehicle sensor 14 includes a speed sensor that detects the speed of the vehicle 100 or an acceleration sensor that detects the acceleration of the vehicle 100. The vehicle sensor 14 outputs a detection result of the state of the vehicle 100 to the ECU 30 via the in-vehicle network 21 at a predetermined interval.

The HMI 15 is an interface for inputting and outputting information between the driver or an occupant and the notification system 1. The HMI 15 includes an information-providing device for providing various types of information to the driver or the occupant, and an input device for the driver or the occupant to perform an input operation.

Specifically, the HMI 15 includes, as the information-providing device, a display 16 for displaying character information or image information. The display 16 is an example of a display device that displays an image. The display 16 is a display device of any type, such as a liquid crystal display or an organic EL display. The display 16 is disposed so that at least the driver can check the screen thereof. Therefore, the display 16 is disposed at an instrument panel or a meter panel of the vehicle 100, for example. The display 16 receives an image signal from the ECU 30 via the in-vehicle network 21 and displays an image in accordance with the image signal. Note that the vehicle 100 may include, as the information-providing device, a display device of another type, such as a head-up display, instead of or in addition to the display 16.

Further, the HMI 15 also includes a speaker 17 as the information-providing device. The speaker 17 is an example of a device that outputs sound. The speaker 17 receives a sound signal from the ECU 30 via the in-vehicle network 21 and outputs sound in accordance with the sound signal. Note that the HMI 15 may include, as the information-providing device, a device other than the display 16 and the speaker 17 that provide various types of information to the driver or the occupant (for example, a vibration device).

In addition, the HMI 15 includes a touch panel 18 as an input device. The touch panel 18 is an example of a device to which an input is performed by the driver or the occupant touching the touch panel 18. When the driver or the occupant performs an operation by contact, the touch panel 18 outputs an operation signal to the ECU 30 via the in-vehicle network 21. Note that the HMI 15 may include, as the input device, a device other than the touch panel 18 for the driver or the occupant to perform the input operation (for example, a button or a switch).

### Configuration of Notification Device

The ECU 30 functions as a notification device that notifies the driver of the vehicle 100 of the start of movement of the preceding vehicle. Further, the ECU 30 controls information provided by the information-providing device of the HMI 15. Therefore, the ECU 30 controls the image displayed on the display 16 and the sound output from the speaker 17. As illustrated in FIG. 1, the ECU 30 includes a communication interface 31, a storage unit 32, and a processor 33.

The communication interface 31 is a circuit for connecting the ECU 30 to the in-vehicle network 21.

The storage unit 32 stores data. The storage unit 32 includes at least one of a volatile semiconductor memory, a nonvolatile semiconductor memory, a hard disk drive (HDD), and a solid state drive (SSD), for example. The storage unit 32 stores a computer program executed by the processor 33 of the ECU 30. Further, the storage unit 32 stores data used in the computer program executed by the processor 33 such as data transmitted from the driver monitor camera 11, for example.

The processor 33 includes one or a plurality of central processing units (CPUs) and peripheral circuits thereof. The processor 33 may further include another arithmetic circuit such as a logical arithmetic unit or a numerical arithmetic unit. The processor 33 executes the computer program stored in the storage unit 32.

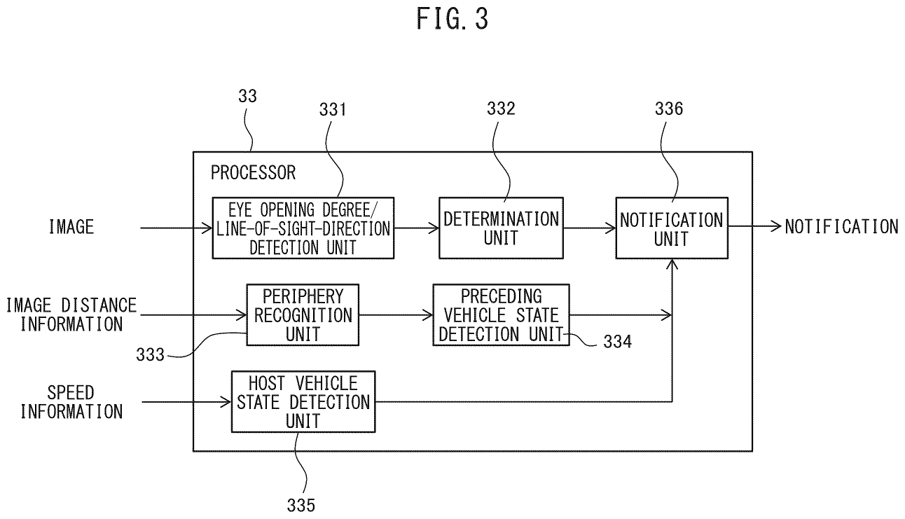

FIG. 3 is a functional block diagram of the processor 33 of the ECU 30. As illustrated in FIG. 3, the processor 33 includes an eye opening degree/line-of-sight-direction detection unit 331, a determination unit 332, a periphery recognition unit 333, a preceding vehicle state detection unit 334, a host vehicle state detection unit 335, and a notification unit 336.

The eye opening degree/line-of-sight-direction detection unit 331 detects the eye opening degree of the driver and the line-of-sight direction of the driver, based on the image captured by the driver monitor camera 11. In the present embodiment, the eye opening degree is expressed as the distance between the upper and lower eyelids. Further, in the present embodiment, the line-of-sight direction is represented by an angle in the horizontal direction or the vertical direction between the front-rear direction of the vehicle 100 and the line of sight of the driver. The eye opening degree/line-of-sight-direction detection unit 331 inputs, to the determination unit 332, the information of the eye opening degree and the line-of-sight direction of the driver detected by the eye opening degree/line-of-sight-direction detection unit 331.

The eye opening degree/line-of-sight-direction detection unit 331 detects the eye opening degree and the line-of-sight direction of the driver by any method based on the image captured by the driver monitor camera 11. For example, the eye opening degree/line-of-sight-direction detection unit 331 inputs the image acquired from the driver monitor camera 11 to a discriminator that recognizes the upper eyelid and the lower eyelid, and detects the distance between the recognized upper eyelid and lower eyelid as the eye opening degree.

Further, the eye opening degree/line-of-sight-direction detection unit 331 inputs, for example, the image acquired from the driver monitor camera 11 to a discriminator that has been trained in advance so as to identify the positions of the pupil and the corneal reflection of a light source. Then, the eye opening degree/line-of-sight-direction detection unit 331 detects the line-of-sight direction based on the identified positional relationship between the pupil and the corneal reflection. As such a discriminator, for example, a convolutional neural network (CNN) is used that outputs the positions of the pupil and the corneal reflection when a facial image is input. Alternatively, the eye opening degree/line-of-sight-direction detection unit 331 may input the image acquired from the driver monitor camera 11 to a discriminator that identifies the positions of the inner corner of the eye and the iris of the eye of the driver. In this case, the eye opening degree/line-of-sight-direction detection unit 331 detects the line-of-sight direction based on the identified positional relationship between the inner corner of the eye and the iris.

The determination unit 332 determines whether or not the driver is visually checking the forward direction. In the present embodiment, the determination unit 332 acquires information of the eye opening degree and the line-of-sight direction of the driver from the eye opening degree/line-of-sight-direction detection unit 331, and determines whether or not the driver is visually checking the forward direction based on this information. For example, in a case where the eye opening degree is less than a predetermined threshold value, the determination unit 332 determines that the driver has their eyes closed and the driver is not visually checking the forward direction. On the other hand, in a case where the eye opening degree is equal to or greater than the predetermined threshold value, for example, when the line-of-sight direction of the driver is within a predetermined angle (for example, 10°) with respect to the front-rear direction of the vehicle 100 and also within a predetermined angle (for example, 10°) with respect to the horizontal direction (or the direction parallel to the road), the determination unit 332 determines that the driver is visually checking the forward direction. On the other hand, when the line-of-sight direction of the driver is larger than the above-described predetermined angle with respect to the front-rear direction of the vehicle 100, or when the line-of-sight direction of the driver is larger than the above-described predetermined angle with respect to the horizontal direction (or the direction parallel to the road), the determination unit 332 determines that the driver is not visually checking the forward direction. The determination unit 332 inputs, to the notification unit 336, a determination result as to whether or not the driver is visually checking the forward direction.

Note that, in the present embodiment, the determination unit 332 determines whether or not the driver is visually checking the forward direction based on the eye opening degree and the line-of-sight direction of the driver. However, the determination unit 332 may determine whether or not the driver is visually checking the forward direction based on a parameter other than the eye opening degree and the line-of-sight direction of the driver. For example, whether or not the driver is visually checking the forward direction may be determined based on the direction of the face of the driver.

The periphery recognition unit 333 recognizes an object present in the surroundings of the vehicle 100 and estimates the relative position of the object with respect to the vehicle 100, based on the output of the vehicle exterior camera 12 and the output of the ranging sensor 13. In particular, in the present embodiment, the periphery recognition unit 333 recognizes the preceding vehicle positioned in the forward direction of the vehicle 100 and estimates the relative position (relative distance) of the preceding vehicle with respect to the vehicle 100. The periphery recognition unit 333 inputs information of the object present in the surroundings of the vehicle 100 to the preceding vehicle state detection unit 334.

For example, in a case where LIDAR is used as the ranging sensor 13, the periphery recognition unit 333 groups point group data output from the LIDAR for each piece of data having an equal distance, and performs grouping for each of groups representing a target object, by grouping together related groups. Further, the periphery recognition unit 333 recognizes an object represented in an image captured by the vehicle exterior camera 12, by performing recognition processing on the image. Then, the periphery recognition unit 333 estimates the relative position of the object with respect to the vehicle 100 based on the target object group at the position corresponding to the position of the object in the image recognized by the recognition processing. In particular, the periphery recognition unit 333 estimates the center position of the target object group as the center position of the object. Note that the relative position of the object with respect to the vehicle 100 may be estimated by a different method using the vehicle exterior camera 12 and the ranging sensor 13. Further, the relative position of the object with respect to the vehicle 100 may be estimated based on only the vehicle exterior camera 12, only the ranging sensor 13, or a sensor different from these sensors.

The preceding vehicle state detection unit 334 detects the state of the preceding vehicle located in front of the vehicle 100. In the present embodiment, the preceding vehicle state detection unit 334 acquires information of objects present in the surroundings of the vehicle 100 from the periphery recognition unit 333, and detects the state of the preceding vehicle based on this information. The preceding vehicle state detection unit 334 detects the state of the preceding vehicle based on the information of the preceding vehicle among the information of the objects acquired from the preceding vehicle state detection unit 334. In particular, in the present embodiment, the preceding vehicle state detection unit 334 detects the presence or absence of the preceding vehicle positioned in front of the vehicle 100 in the same lane as the vehicle 100, and, when the preceding vehicle is present, detects the distance and the relative speed between the vehicle 100 and the preceding vehicle (or the speed of the preceding vehicle). In a case where the output of the ranging sensor 13 includes information of a relative speed with respect to a peripheral object, the relative speed between the vehicle 100 and the preceding vehicle is detected using this information. On the other hand, in a case where such information is not included in the output of the ranging sensor 13, the relative speed between the vehicle 100 and the preceding vehicle is detected based on time-series relative positions of the preceding vehicle. Further, the speed of the preceding vehicle is calculated based on the speed of the vehicle 100 detected by the host vehicle state detection unit 335 to be described later and the relative speed between the vehicle 100 and the preceding vehicle. The preceding vehicle state detection unit 334 of the vehicle 100 outputs information of the state of the preceding vehicle to the notification unit 336.

The host vehicle state detection unit 335 detects the state of the vehicle 100. In the present embodiment, the host vehicle state detection unit 335 detects the speed of the vehicle 100 based on the output of the vehicle sensor 14. In a case where the vehicle sensor 14 is a speed sensor, the host vehicle state detection unit 335 calculates the speed corresponding to the output of the vehicle sensor 14. The host vehicle state detection unit 335 outputs the information of the speed of the vehicle 100 to the notification unit 336.

When the preceding vehicle starts to move from a stopped state, the notification unit 336 notifies the driver of the start of movement of the preceding vehicle. For example, when the preceding vehicle starts to move from the stopped state, the notification unit 336 causes the display 16 to display the fact that the preceding vehicle has started to move, and causes the speaker 17 to output a sound indicating the fact that the preceding vehicle has started to move.

In particular, in the present embodiment, a notification mode of notifying the driver of the start of movement of the preceding vehicle based on the state of the preceding vehicle detected by the preceding vehicle state detection unit 334 is changed between the case where the determination unit 332 determines that the driver is visually checking the forward direction and the case where the determination unit 332 determines that the driver is not visually checking the forward direction. Here, the notification mode includes at least any one of a timing of notification to the driver, presence or absence of notification to the driver, and a method of notification to the driver.

In particular, in the present embodiment, in the case where the determination unit 332 determines that the driver is not visually checking the forward direction, the notification unit 336 notifies the driver of the start of movement of the preceding vehicle at an earlier timing, from the start of movement of the preceding vehicle, compared to the case where the determination unit 332 determines that the driver is visually checking the forward direction. Therefore, in the present embodiment, the notification unit 336 changes the timing of the notification to the driver based on whether or not the driver is visually checking the forward direction.

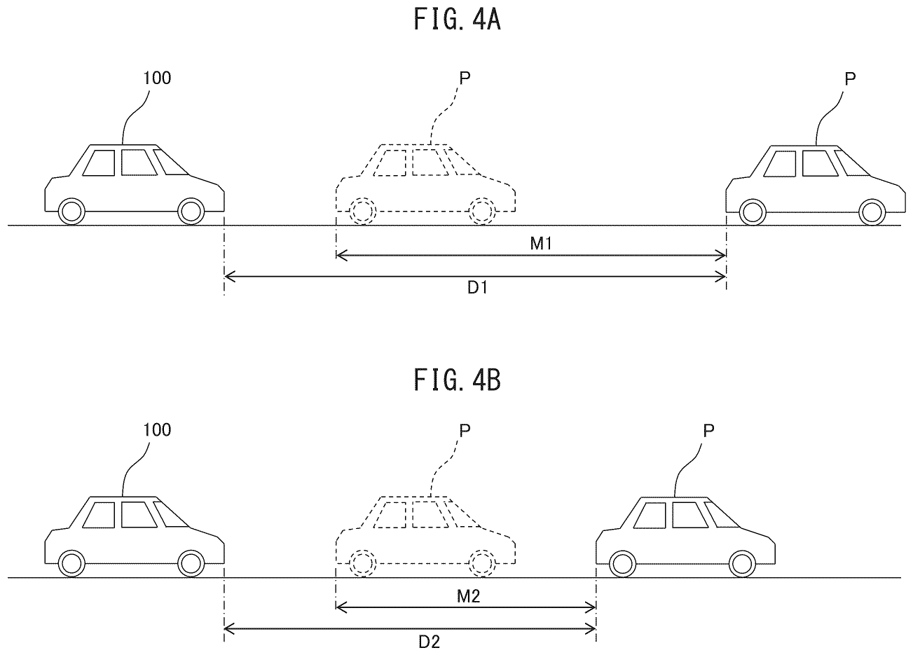

FIGS. 4A and 4B are diagrams for explaining the timing of notifying the start of movement of a preceding vehicle P. In FIGS. 4A and 4B, positional relationships between the vehicle 100 and the preceding vehicle P are illustrated, and broken lines in the figures illustrate the position of the preceding vehicle P in a stopped state before starting to move. In particular, FIG. 4A illustrates a case where the driver is visually checking the forward direction, and FIG. 4B illustrates a case where the driver is not visually checking the forward direction.

In the present embodiment, in a case where the preceding vehicle P has started to move from the stopped state, when the movement amount of the preceding vehicle P, from the preceding vehicle P starting to move, becomes equal to or greater than a predetermined reference value, the notification unit 336 notifies the driver of the start of movement of the preceding vehicle P. Specifically, the notification unit 336 calculates the movement amount of the preceding vehicle P, from the preceding vehicle P starting to move from the stopped state, based on the state of the preceding vehicle detected by the preceding vehicle state detection unit 334. Then, when the calculated movement amount becomes equal to or greater than the predetermined reference value, the notification unit 336 notifies the driver of the start of movement of the preceding vehicle P.

In particular, in the present embodiment, as illustrated in FIG. 4A, in the case where the driver is visually checking the forward direction, the notification unit 336 notifies the driver of the start of movement of the preceding vehicle P when the movement amount of the preceding vehicle P becomes equal to or greater than a first movement amount M1.

On the other hand, in the present embodiment, as illustrated in FIG. 4B, in the case where the driver is not visually checking the forward direction, the notification unit 336 notifies the driver of the start of movement of the preceding vehicle P when the movement amount of the preceding vehicle P becomes equal to or greater than a second movement amount M2. Here, the second movement amount M2 is less than the first movement amount M1. Therefore, in the present embodiment, in the case where the driver is not visually checking the forward direction, the notification to the driver is performed even when the movement amount of the preceding vehicle P, from the preceding vehicle P starting to move from the stopped state, is smaller compared to the case where the driver is visually checking the forward direction.

Note that, the first movement amount M1 and the second movement amount M2 are values determined in advance. However, the first movement amount M1 and the second movement amount M2 may be values that change in accordance with the brightness outside the vehicle (whether it is daytime or nighttime), for example. However, even in this case, the second movement amount M2 is always set to a value less than the first movement amount M1.

In this way, according to the present embodiment, the notification mode of notifying the driver of the start of movement of the preceding vehicle is changed based on whether or not the driver is visually checking the forward direction. As a result, the driver can be notified of the start of movement of the preceding vehicle in accordance with the state of the driver. In particular, in the present embodiment, since the notification to the driver is performed at an earlier timing in the case where the driver is not visually checking the forward direction, the driver can be appropriately notified of the start of movement of the preceding vehicle in accordance with the state of the driver.

### Control Flow

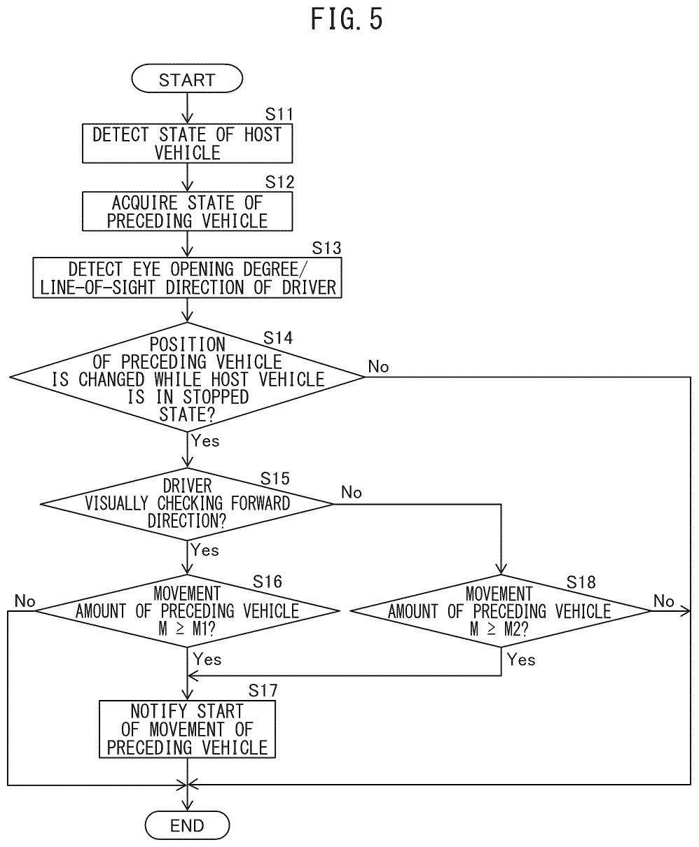

FIG. 5 is a flowchart illustrating a flow of notification processing performed by the notification device. The illustrated notification processing is executed by the processor 33 of the ECU 30 at a fixed time interval.

As illustrated in FIG. 5, in the notification processing, first, the host vehicle state detection unit 335 detects the state of the host vehicle 100 (step S11). In the present embodiment, the host vehicle state detection unit 335 detects the speed of the vehicle 100. Subsequently, the preceding vehicle state detection unit 334 detects the state of the preceding vehicle (step S12). In the present embodiment, the preceding vehicle state detection unit 334 detects, for example, the distance to the preceding vehicle and the speed of the preceding vehicle. Subsequently, the eye opening degree/line-of-sight-direction detection unit 331 detects the eye opening degree and the line-of-sight direction of the driver (step S13). Note that, in the present notification processing, the detection of the state of the vehicle 100 by the host vehicle state detection unit 335, the detection of the state of the preceding vehicle by the preceding vehicle state detection unit 334, and the detection of the eye opening degree and the line-of-sight direction by the eye opening degree/line-of-sight-direction detection unit 331 are performed in this order. However, these detections may be performed in any order, or alternatively may be performed entirely or partially simultaneously.

Subsequently, the determination unit 332 determines whether or not the position of the preceding vehicle has changed while the vehicle 100 is in a stopped state (step S14). Specifically, in a case where the speed of the vehicle 100 detected at step S11 is zero and the speed of the preceding vehicle detected at step S12 is not zero, the determination unit 332 determines that the position of the preceding vehicle has changed while the vehicle 100 is in a stopped state. On the other hand, in a case where the speed of the vehicle 100 detected at step S11 is not zero or a case where the speed of the preceding vehicle detected at step S12 is zero, the determination unit 332 determines that the position of the preceding vehicle has not changed while the vehicle 100 is in a stopped state. In a case where it is determined at step S14 that the position of the preceding vehicle has not changed while the vehicle 100 is in a stopped state, the notification processing is terminated. Therefore, in this case, the driver is not notified of the fact that the preceding vehicle has started to move. Note that, in the present embodiment, at step S14, the determination unit 332 determines whether or not the position of the preceding vehicle has changed while the vehicle 100 is in a stopped state. However, the determination unit 332 may determine only whether or not the vehicle 100 is in the stopped state.

In the case where it is determined at step S14 that the position of the preceding vehicle has changed while the vehicle 100 is in a stopped state, the determination unit 332 determines whether or not the driver is visually checking the forward direction (step S15). Whether or not the driver is visually checking the forward direction is determined based on the eye opening degree and the line-of-sight direction detected by the eye opening degree/line-of-sight-direction detection unit 331 at step S13.

In a case where it is determined at step S15 that the driver is visually checking the forward direction, the notification unit 336 determines whether or not a movement amount M of the preceding vehicle, from the preceding vehicle starting to move from a stopped state, is equal to or greater than the first movement amount M1 (step S16). The movement amount M of the preceding vehicle, from the preceding vehicle starting to move from the stopped state, is calculated based on the state of the preceding vehicle detected at step S12.

In a case where it is determined at step S16 that the movement amount M of the preceding vehicle is less than the first movement amount M1, the notification processing is terminated. Therefore, in this case, the driver is not notified of the fact that the preceding vehicle has started to move. On the other hand, in a case where it is determined at step S16 that the movement amount M of the preceding vehicle is equal to or greater than the first movement amount M1, the notification unit 336 notifies the driver of the fact that the preceding vehicle has started to move (step S17). In the present embodiment, the notification unit 336 causes the display 16 to display the fact that the preceding vehicle has started to move, and causes the speaker 17 to output the sound indicating the fact that the preceding vehicle has started to move.

On the other hand, in a case where it is determined at step S15 that the driver is not visually checking the forward direction, the notification unit 336 determines whether or not the movement amount M of the preceding vehicle, from the preceding vehicle starting to move from the stopped state, is equal to or greater than the second movement amount M2 (M2<M1) (step S18). The movement amount M of the preceding vehicle, from the preceding vehicle starting to move from the stopped state, is calculated based on the state of the preceding vehicle detected at step S12.

In a case where it is determined at step S18 that the movement amount M of the preceding vehicle is less than the second movement amount M2, the notification processing is terminated. Therefore, in this case, the driver is not notified of the fact that the preceding vehicle has started to move. On the other hand, in a case where it is determined at step S18 that the movement amount M of the preceding vehicle is equal to or greater than the second movement amount M2, the notification unit 336 notifies the driver of the fact that the preceding vehicle has started to move (step S17).

### Variations

In the embodiment described above, in a case where the preceding vehicle P has started to move from the stopped state, when the movement amount of the preceding vehicle, from the preceding vehicle starting to move, becomes equal to or greater than the predetermined reference value, the notification unit 336 notifies the driver of the start of movement of the preceding vehicle.

However, in one variation, in the case where the preceding vehicle P has started to move from the stopped state, the notification unit 336 may notify the driver of the start of movement of the preceding vehicle when the elapsed time from the preceding vehicle starting to move becomes equal to or greater than a predetermined time period. In this case, in a case where the determination unit 332 determines that the driver is visually checking the forward direction, the notification unit 336 notifies the driver of the start of movement of the preceding vehicle when the elapsed time from the preceding vehicle starting to move becomes equal to or greater than a first time period. Further, in a case where the determination unit 332 determines that the driver is not visually checking the forward direction, the notification unit 336 notifies the driver of the start of movement of the preceding vehicle when the elapsed time from the preceding vehicle starting to move becomes equal to or greater than a second time period. Here, the second time period is shorter than the first time period. Therefore, also in the present variation, in the case where the driver is not visually checking the forward direction, the notification to the driver is performed at an earlier timing compared to the case where the driver is visually checking the forward direction.

Note that, the first time period and the second time period are fixed values determined in advance. However, the first time period and the second time period may be values that change in accordance with, for example, the brightness outside the vehicle. However, even in this case, the second time period is always set to a value less than the first time period. Further, the elapsed time may be an elapsed time during movement of the preceding vehicle. Therefore, the elapsed time may be a time period that progresses while the preceding vehicle is moving and that stops while the preceding vehicle is in the stopped state.

Further, in another variation, in the case where the preceding vehicle P has started to move from the stopped state, the notification unit 336 may notify the driver of the start of movement of the preceding vehicle when the distance from the vehicle 100 to the preceding vehicle becomes equal to or greater than a predetermined reference value. In this case, as illustrated in FIGS. 4A and 4B, in the case where the determination unit 332 determines that the driver is visually checking the forward direction, the notification unit 336 notifies the driver of the start of movement of the preceding vehicle when the distance from the vehicle 100 to the preceding vehicle becomes equal to or greater than a first distance D1. Further, in the case where the determination unit 332 determines that the driver is not visually checking the forward direction, the notification unit 336 notifies the driver of the start of movement of the preceding vehicle when the distance from the vehicle 100 to the preceding vehicle is equal to or greater than a second distance D2. Here, the second distance D2 is smaller than the first distance D1. Therefore, also in the present variation, in the case where the driver is not visually checking the forward direction, the notification to the driver is performed at an earlier timing compared to the case where the driver is visually checking the forward direction.

Note that, the first distance and the second distance are values determined in advance. However, the first distance and the second distance may be values that change in accordance with, for example, the brightness outside the vehicle. However, even in this case, the second distance is always set to a value less than the first distance.

Further, in the embodiment described above, the driver is notified of the start of movement of the preceding vehicle by the same notification method regardless of whether or not the driver is visually checking the forward direction. However, the driver may be notified of the start of movement of the preceding vehicle by different notification methods in accordance with whether or not the driver is visually checking the forward direction. For example, in the case where it is determined that the driver is visually checking the forward direction, the notification by the speaker 17 may be performed but the notification by the display 16 may not be performed, and in the case where it is determined that the driver is not visually checking the forward direction, the notification by both the speaker 17 and the display 16 may be performed. Alternatively, in the case where it is determined that the driver is visually checking the forward direction, the notification may be performed by the speaker 17 with a smaller notification volume compared to the case where it is determined that the driver is not visually checking the forward direction. Further, in a case where the driver is notified of the start of movement of the preceding vehicle by different notification methods in accordance with whether or not the driver is visually checking the forward direction, the timing of the notification to the driver need not necessarily be changed in accordance with whether or not the driver is visually checking the forward direction.

### Second Embodiment

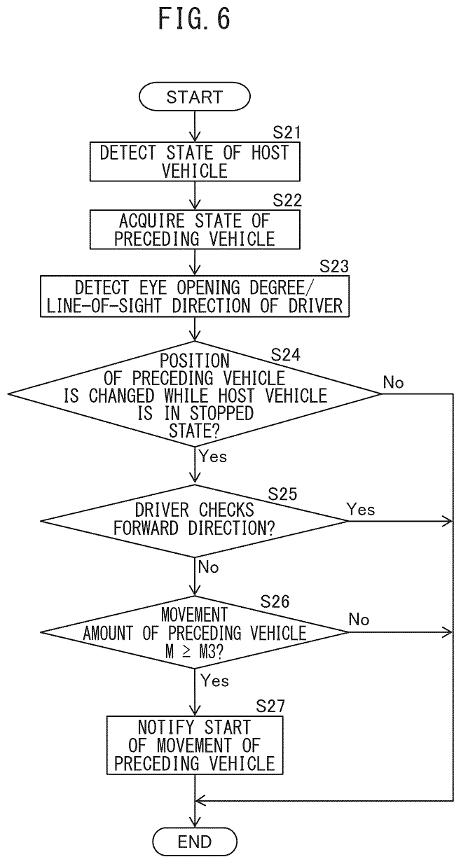

Next, the notification device according to a second embodiment will be described with reference to FIG. 6. The configuration and control of the notification device according to the second embodiment are basically the same as the configuration and control of the notification device according to the first embodiment. Hereinafter, the control of the notification device according to the second embodiment will be described focusing primarily on points that differ from the notification device according to the first embodiment.

In the first embodiment described above, the driver is notified of the start of movement of the preceding vehicle when the preceding vehicle starts to move while the vehicle 100 is in a stopped state, regardless of whether or not the driver is visually checking the forward direction. However, in the second embodiment, when the driver is visually checking the forward direction, even when the preceding vehicle starts to move while the vehicle 100 is in a stopped state, the driver is not notified of the start of movement of the preceding vehicle. Therefore, in the present second embodiment, the notification mode of notifying the driver of the start of movement of the preceding vehicle (in particular, the presence or absence of notification to the driver) based on the state of the preceding vehicle detected by the preceding vehicle state detection unit 334 is changed between the case where the determination unit 332 determines that the driver is visually checking the forward direction and the case where the determination unit 332 determines that the driver is not visually checking the forward direction. As a result, situations are reduced in which the driver is inconvenienced by being notified of the start of movement of the preceding vehicle even when the driver is visually checking the forward direction.

FIG. 6 is a flowchart illustrating a flow of notification processing performed by the notification device according to the second embodiment. The illustrated notification processing is executed by the processor 33 of the ECU 30 at a fixed time interval. Note that, steps S21 to S24 and S27 in FIG. 6 are the same as steps S11 to S14 and S17 in FIG. 5, respectively, and therefore, a description thereof is omitted.

As illustrated in FIG. 6, in the notification processing according to the second embodiment, in a case where it is determined at step S24 that the position of the preceding vehicle has changed while the vehicle 100 is in a stopped state, the determination unit 332 determines whether or not the driver is visually checking the forward direction (step S25). In a case where it is determined at step S25 that the driver is visually checking the forward direction, the notification processing is terminated. Therefore, in this case, the driver is not notified of the fact that the preceding vehicle has started to move.

On the other hand, in a case where it is determined at step S25 that the driver is not visually checking the forward direction, the notification unit 336 determines whether or not the movement amount M of the preceding vehicle, from the preceding vehicle starting to move from the stopped state is equal to or greater than a third movement amount M3 (step S26). The third movement amount M3 may be a fixed value determined in advance, or may be a value that changes in accordance with, for example, the brightness outside the vehicle.

In a case where it is determined at step S26 that the movement amount M of the preceding vehicle is less than the third movement amount M3, the notification processing is terminated. Therefore, in this case, the driver is not notified of the fact that the preceding vehicle has started to move. On the other hand, in a case where it is determined at step S26 that the movement amount M of the preceding vehicle is equal to or greater than the third movement amount M3, the notification unit 336 notifies the driver of the fact that the preceding vehicle has started to move (step S27).

Although the preferred embodiments according to the present disclosure have been described above, the present disclosure is not limited to these embodiments, and various modifications and changes can be made within the scope of the claims.

1. A notification device that notifies a driver of a host vehicle of a start of movement of a preceding vehicle that is in a stopped state in front of the host vehicle, the notification device comprising a processor, the processor is configured to:
determine whether the driver is visually checking a forward direction;
detect a state of the preceding vehicle; and
notify the driver of the start of movement of the preceding vehicle, wherein
the processor is configured to change a notification mode of notifying the driver of the start of movement of the preceding vehicle, between a case where it is determined that the driver is visually checking the forward direction and a case where it is determined that the driver is not visually checking the forward direction, the notifying being based on the state of the preceding vehicle detected by the state detection unit, and
the notification mode includes at least one of a timing of a notification, presence or absence of the notification, and a notification method.

2. The notification device according to claim 1, wherein
the processor is configured to notify the driver of the start of movement of the preceding vehicle at an earlier timing, from the start of movement of the preceding vehicle, when it is determined that the driver is not visually checking the forward direction, compared to when it is determined that the driver is visually checking the forward direction.

3. The notification device according to claim 2, wherein
when it is determined that the driver is visually checking the forward direction, the processor is configured to notify the driver of the start of movement of the preceding vehicle when a movement amount of the started preceding vehicle becomes equal to or greater than a first movement amount, and, when it is determined that the driver is not visually checking the forward direction, the processor is configured to notify the driver of the start of movement of the preceding vehicle when the movement amount of the started preceding vehicle becomes equal to or greater than a second movement amount, the second movement amount being smaller than the first movement amount.

4. The notification device according to claim 2, wherein
when it is determined that the driver is visually checking the forward direction, the processor is configured to notify the driver of the start of movement of the preceding vehicle when an elapsed time from the preceding vehicle starting to move becomes equal to or greater than a first time period, and, when it is determined that the driver is not visually checking the forward direction, the processor is configured to notify the driver of the start of movement of the preceding vehicle when the elapsed time from the preceding vehicle starting to move becomes equal to or greater than a second time period, the second time period being shorter than the first time period.

5. The notification device according to claim 2, wherein
when it is determined that the driver is visually checking the forward direction, the processor is configured to notify the driver of the start of movement of the preceding vehicle when a distance from the host vehicle to the preceding vehicle becomes equal to or greater than a first distance, and, when it is determined that the driver is not visually checking the forward direction, the processor is configured to notify the driver of the start of movement of the preceding vehicle when the distance from the host vehicle to the preceding vehicle becomes equal to or greater than a second distance, the second distance being less than the first distance.

6. The notification device according to claim 1, wherein
when it is determined that the driver is visually checking the forward direction, the processor is configured not to notify the driver of the start of movement of the preceding vehicle even when the start of movement of the preceding vehicle is detected.

7. A notification method performed by a processor of a host vehicle for notifying a driver of the host vehicle of a start of movement of a preceding vehicle that is in a stopped state in front of the host vehicle, the notification method comprising:
determining whether the driver is visually checking a forward direction;
detecting a state of the preceding vehicle; and
notifying the driver of the start of movement of the preceding vehicle, wherein
when notifying the driver of the start of movement of the preceding vehicle, a notification mode of notifying the driver of the start of movement of the preceding vehicle is changed, between a case where it is determined that the driver is visually checking the forward direction and a case where it is determined that the driver is not visually checking the forward direction, the notifying being based on the state of the preceding vehicle, and
the notification mode includes at least one of a timing of a notification, presence or absence of the notification, and a notification method.

8. A non-transitory recording medium having recorded thereon a computer program for notifying a driver of a host vehicle of a start of movement of a preceding vehicle that is in a stopped state in front of the host vehicle, the computer program causing a computer to execute:
determining whether the driver is visually checking a forward direction;
detecting a state of the preceding vehicle; and
notifying the driver of the start of movement of the preceding vehicle, wherein
when notifying the driver of the start of movement of the preceding vehicle, a notification mode of notifying the driver of the start of movement of the preceding vehicle is changed, between a case where it is determined that the driver is visually checking the forward direction and a case where it is determined that the driver is not visually checking the forward direction, the notifying being based on the state of the preceding vehicle, and
the notification mode includes at least one of a timing of a notification, presence or absence of the notification, and a notification method.
